(19) United States
(12) Patent Application Publication
(10) Pub. No.: US 2020/0070615 A1
(43) Pub. Date: Mar. 5, 2020

(54) Control Device For Controlling At Least One Adjustable Vibration Damper

(71) Applicant: ZF FRIEDRICHSHAFEN AG, Friedrichshafen (DE)

(72) Inventor: Roland NIKIEL, Uchtelhausen (DE)

(21) Appl. No.: 16/542,967

(22) Filed: Aug. 16, 2019

(30) Foreign Application Priority Data
Aug. 28, 2018 (DE) 102018214509.1

(51) Int. Cl. B60G 17/08

(52) U.S. Cl. CPC B60G 17/08; B60G 2800/162; B60G 2600/1871; B60G 2400/5182

(57) ABSTRACT

A control device for controlling at least one adjustable vibration damper, having a sensor arrangement inside of a housing of the control device that senses the movement of a vehicle body. A damper adjustment is determined using further parameters. The further parameters are determined from the signals of the sensor arrangement by a filter system.

### BACKGROUND OF THE INVENTION

### 1. Field of the Invention

The invention is directed to a control device for controlling at least one adjustable vibration damper.

### 2. Description of the Related Art

In current chassis systems, a control device for controlling the components, including an adjustable vibration damper is connected to an onboard CAN bus to utilize the signals of different sensors in the vehicle collectively via this line system. The CAN bus system makes sensor signals available for different systems in order to avoid a duplicate arrangement of identical sensors for different systems.

However, line standards and component standards are required in a vehicle for the CAN bus to function. A subsequent implantation of systems or sensors is hardly possible. A CAN bus system is also only worthwhile in vehicles with a high exchange of data between the different vehicle systems. Therefore, simple vehicles do not have a CAN bus system.

EP 2 570 277 B1 describes a control device in which all of the acceleration signals that represent motion of the vehicle body are combined in a control device. Accelerations at the wheel articulation points are determined by extrapolating from a small measuring plane to the plane of the vehicle body. Further, the control device has signal inputs for further parameters in order to receive a steering wheel signal, for example. However, a control device of this kind cannot be used in a simple vehicle because this control device depends on a CAN bus.

### SUMMARY OF THE INVENTION

It is an object of one aspect of the present invention to develop a control device that also provides a basic control for at least one vibration damper while dispensing with a CAN bus connection, which is met in that the further parameters are determined from the signals of the sensor arrangement by a filter system.

The move toward an appreciable simplification and reduction of components and separate signals leads to a particularly simple control device that substantially contributes to comfort for numerous applications compared to a conventional, i.e., nonadjustable, chassis.

As a result of this simplification, the control device and the adjustable vibration damper cooperating with the control device can be retrofitted in a vehicle. Owing to the independent arrangement, it is not important whether or not a CAN bus system is installed in the vehicle. Therefore, even very limited-production vehicles for which the expenditure on CAN bus systems would not be reasonable can be outfitted with adjustable vibration dampers.

In a further advantageous configuration, the filter system of the control device has a filter that determines a signal corresponding to a road excitation on a vehicle axle from the vertical body acceleration of the vehicle. This replaces acceleration sensors at spring-loaded axle parts. This replaces not only vertical acceleration sensors at the wheels, but also the cabling connected thereto, which is not only expensive but is also exposed to a heightened risk of damage in vehicles that are used on rough terrain.

A further problem consists in how to determine the load state of the vehicle in a simple system. This signal can be obtained very simply with sufficient quality in that a load state of the vehicle can be entered via a selector switch.

The control algorithm is preferably configured such that the driving speed has no influence on the damping force adjustment of the vibration damper. Extensive analyses have shown that the target vehicles are driven relatively slowly, often also off of high-speed roads. Therefore, in a simplified manner, the speed is set to a fixed value, which can vary depending on the vehicle. However, should there be a demand for a speed signal in order to maintain the variability of the influence of speed, the control device has a connection for a signal line to a wheel speed sensor. A wheel speed sensor is very easy to access and, therefore, a signal line connection can be installed economically. The wheel speed also need not be detected on every wheel; a single wheel speed signal is entirely sufficient.

The control device has a power plug for the power supply particularly for an especially simple retrofitting. The power plug can be connected in a very simple matter to a line carrying continuous current or ignition current as part of the onboard power supply of the vehicle, e.g., to the line for a plug socket such as is provided for external consumers in many vehicles.

A further step toward simplifying the overall system consists in that only a portion of the utilized vibration dampers are connected to the control device. Tests have shown that the axle with variable static load should be outfitted with adjustable vibration dampers. A considerable gain in comfort can be achieved through this outfitting alone.

During operation of the control device, a case differentiation between stationary cornering and dynamic cornering is determined from the ratio of a rotation rate signal of the sensor arrangement and a derivation of a transverse acceleration signal with respect to time. This simple case differentiation suffices for a damping force adjustment. Accordingly, a lower-power computer which is more robust and therefore also better suited for off-road vehicles can be used.

For a good sense of comfort, a higher weighting factor is applied when determining the damping force adjustment with respect to a pitch movement of the vehicle body around a transverse axis than for a roll movement of the vehicle body around a longitudinal axis. The roll movement is highly dependent on the driving speed. However, pitch movements occur even at low driving speeds in off-road operation.

In order to perform the required damping force adaptation of the vibration dampers, a pitch movement is determined from a rotation rate around the transverse axis and a constant mass. In this way, a complicated sensing of the relative motion between the vehicle body and the deflecting axle part can be obviated.

An adaptation of damping force against a pitch movement can be carried out in that the input for the constant mass of the vehicle is linked to the selection mode for the load.

### BRIEF DESCRIPTION OF THE DRAWINGS

The invention will be described more fully referring to the following description of the figures.

The drawings show:

FIG. 1 is a schematic diagram of the chassis system; and

FIG. 2 a control device as separate component of the chassis system.

### DETAILED DESCRIPTION OF THE PRESENTLY PREFERRED EMBODIMENTS

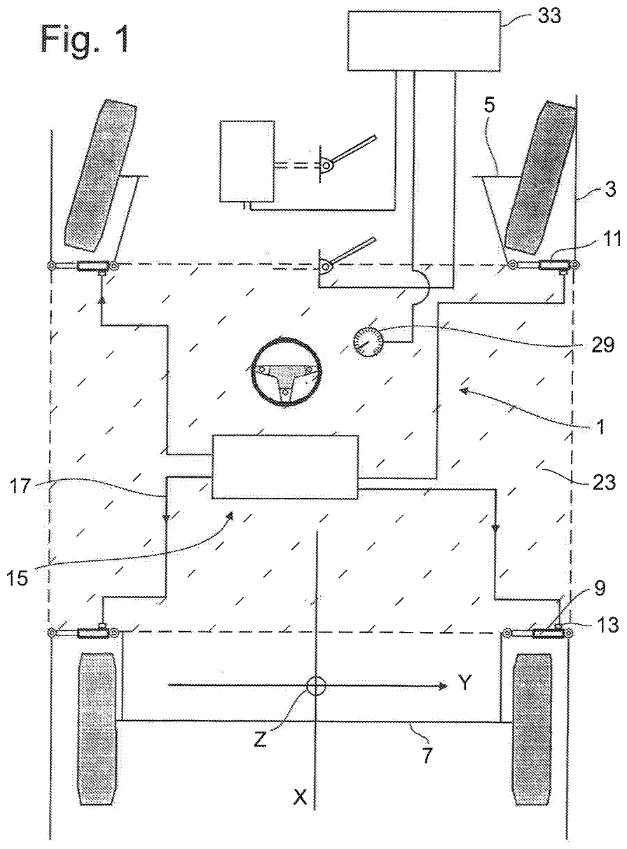

FIG. 1 shows a schematic diagram of a chassis system 1 with a vehicle body 3. At least one of axles 5; 7 of chassis 1 is constructed with vibration dampers 9, 11, which are adjustable with respect to damping force via at least one adjustable damping valve 13. Reference is made to DE 196 24 897 C2, for example. In principle, the invention can also be used in other adjustable chassis systems, e.g., an adjustable stabilizer.

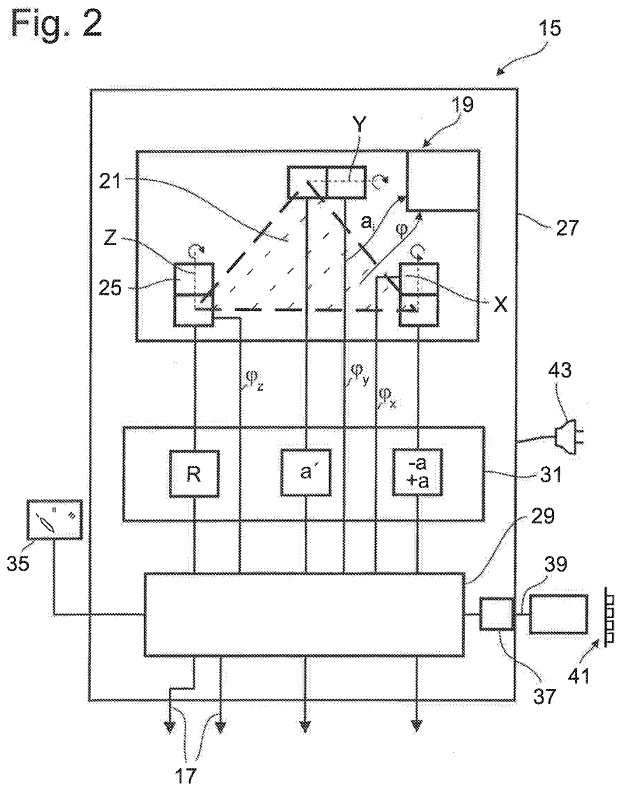

The adjustable damping valves 13 are actuated via a control device 15. All of the damping valves 13 are connected to control device 15 by control lines 17. The basis for the damping valve adjustment is a driving state that is sensed by a sensor arrangement 19 (FIG. 2). In the simplest configuration, the sensor arrangement 19 supplies an acceleration signal a with respect to a vehicle longitudinal axis X, a vehicle transverse axis Y, and a vehicle vertical axis Z. The sensor arrangement 19 is arranged inside of control device 15 and forms a virtual miniature measuring plane 21 which is extrapolated to an actual measuring plane 23. A miniature measuring plane can be defined via three individual sensors, since three points defined with respect to one another in space describe a plane. The vehicle dimensions and the position of the control device 15 in the vehicle are known so that the extrapolation is possible vector algebra.

Sensor arrangement 19 preferably comprises a rotation rate sensor 25 that supplies a rotation rate signal with respect to a vehicle longitudinal axis X, a vehicle transverse axis Y and a vehicle vertical axis Z. The acceleration signals ai are used in addition to the rotation rate sensor signals phi. The control device 15 could be arranged exactly at the center of mass of the vehicle. Considered ideally, no vertical acceleration would occur during a simple roll movement of the vehicle body around the vehicle longitudinal axis X. Consequently, the acceleration signal would be an inaccurate description of the actual driving state. However, the rotation rate signal compensates for this deviation.

The acceleration signal for all three vehicle axes can also be supplied by an individual sensor in a housing 27 of control device 15, which has a computer unit 29 to convert the sensor signals into a damping force adjustment of damping valves 13 based on algorithms. A sensor of this kind has three integrated measuring axes.

Control device 15 is shown ideally related to the coordinate system of the vehicle. In reality, it is much more common that control device 15 must be mounted obliquely in space referring to the actual measuring plane 23, since this arrangement is predetermined by the fastening points in the vehicle. In order to compensate for this angular position of the control device with respect to the measuring plane, the control device has an algorithm that is superposed on the calculation of the measuring plane. The angular position is known in a vehicle-specific manner and the signals determined by the sensor arrangement 19 can be corrected using known angle functions. The signals of the sensor arrangement are projected on the miniature measuring plane 19 in practice.

In addition to the sensor arrangement 19 and the computer unit 29, control device 15 has a filter system 31 that supplies further signals from the signals of the sensor arrangement 19 for parameters representing the state of the vehicle. Accordingly, the vehicle has no sensor arrangement that senses the relative motion of the wheels with respect to the vehicle body 3 so as to determine the influence of the road on the vehicle. For this purpose, the vertical acceleration signal aiz is used and is subjected to high-pass filtration. As a rule, the vehicle body moves at about 1 Hz, while a movement of up to 10 Hz occurs with a spring-mounted wheel. Using this rule, a filtration can be carried out so that fine excitations of the road can be discerned. Below an excitation threshold, the road is simply evaluated as “good”.

The same principle is also used for sensing braking movement or a starting pitch movement of the vehicle body 3. The acceleration signal in direction of longitudinal axis “X” and the rotation rate signal around transverse axis “Y” are filtered out. Accordingly, a sensor for a brake pedal movement is as superfluous as a sensor for a throttle valve for sensing an acceleration. These signals can be used in the vehicle for a motor control 33, although the latter is not connected to control device 15.

Optionally, control device 15 can be connected to a selector switch 35 to submit a load state of the vehicle to the control algorithm in control device 15 via the switch setting of the selector switch 35. This also replaces a complicated sensor arrangement external to control device 15.

If required, a signal representing the driving speed can be supplied to control device 15. For this purpose, control device 15 has a connection 37 for a signal line 39 to a wheel speed sensor 41.

In contrast to conventional control devices, control device 15 has a power plug 43 for the power supply, which is not burdened by pins for the connection to a CAN bus system. Owing to the independent sensor arrangement, power plug 43 is minimalistically outfitted and serves only for the power supply.

In FIG. 1, all vibration dampers 9; 11 and valves 13 thereof are connected to control device 15. In principle, however, it can also be provided that only a portion of the utilized vibration dampers 9; 11 is connected to control device 15.

The actuating currents required for the damping force adjustment of valves 13 are based on vectorial proportions of the sensor arrangement 19. The signals are evaluated in part through simple calculations or table queries. As a substitute for a missing steering angle sensor, a case differentiation between stationary cornering and dynamic cornering is carried out from the ratio of a rotation rate signal of the sensor arrangement and a derivation of a transverse acceleration signal with respect to time. The exact steering behavior is not important for the damping force adjustment in a comparatively slow moving vehicle. What is important are the dynamics of the steering movement which make up a substantial component of the damping force.

A further step for simplifying the control algorithm consists in that a higher weighting factor is applied when determining the damping force adjustment with respect to a pitch movement of the vehicle body around transverse axis Y than for a roll movement of the vehicle body around a longitudinal axis. Obviously, the weighting factor for the pitch movement can be programmed depending on the vehicle. In an off-road vehicle, body motion is more pronounced particularly in case of larger bumps and impacts the comfort of the passengers of the vehicle. This body motion frequently has a greater acceleration than an intended cornering, which leads to a comparatively sluggish rolling movement. Consequently, when traveling on a road with only slight excitations, the damping force can be appreciably reduced compared to a nonadjustable chassis without forfeiting safety reserves for traveling over rougher terrain.

A simplified approach is also selected for determining the pitch movement. The movement can be sensed via the rotation rate sensor for transverse axis Y. In a high-end system, the mass of the body 3 would be determined from the relative position of the wheels with respect to the vehicle body. For this purpose, corresponding sensors would be required for measuring spring deflection, for example, at the vibration dampers. In the present invention, the pitch movement is determined in a simplified matter from a rotation rate around transverse axis Y and a constant mass. By dispensing with an exact measurement which can change, e.g., as a result of different loads, the conditioning of the signal component for damping the pitch movement is also reduced. Optionally, the specification for the constant mass can be linked to the selection mode for the load. The driver can then indirectly intervene in the damping of the pitch movement by assessing the situation and via the position of the selector switch 35.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

I claim:

1. A control device for controlling at least one adjustable vibration damper of a vehicle, comprising:
a housing of the control device;
a sensor arrangement inside the housing configured to sense movement of a vehicle body; and
a filter system configured to determine parameters from signals of the sensor arrangement,
wherein a damper adjustment is determined using the parameters.

2. The control device according to claim 1, wherein the filter system has a filter configured to determine a signal corresponding to a road excitation on a vehicle axle from a vertical body acceleration of the vehicle.

3. The control device according to claim 1, wherein the control device is configured to receive a load state of the vehicle via a selector switch.

4. The control device according to claim 1, wherein the control device has a connection for a signal line to a wheel speed sensor.

5. The control device according to claim 1, wherein the control device has a power plug for a power supply.

6. The control device according to claim 1, wherein only a portion of utilized vibration dampers are connected to the control device.

7. A method for operation of a control device according to claim 1, comprising:
providing a sensor arrangement; and
determining a case differentiation between stationary cornering and dynamic cornering from a ratio of a rotation rate signal of the sensor arrangement and a derivation of a transverse acceleration signal with respect to time.

8. The method according to claim 7, wherein a higher weighting factor is applied when determining a damping force adjustment with respect to a pitch movement of a vehicle body around a transverse axis (Y) than for a roll movement of the vehicle body around a longitudinal axis (X).

9. The method according to claim 7, wherein a pitch movement is determined from a rotation rate around a transverse axis (Y) and a constant mass of the vehicle body.

10. The method according to claim 9, wherein an input for the constant mass of the vehicle body is linked to a selection mode for a load.
